(19) United States
(12) Patent Application Publication
(10) Pub. No.: US 2002/0087645 A1
(43) Pub. Date: Jul. 4, 2002

(54) Automated initiation and propagation by means of electronic mail of devices to provide voice-over-IP and other advanced communications capabilities to recipients of such electronic mail

(76) Inventors: Kent Ertugrul, London (GB); Genady Lakshin, Moscow (RU)

Correspondence Address: BLACK LOWE & GRAHAM, 816 SECOND AVE., SEATTLE, WA, 98104, US

(21) Appl. No.: 09/966,815

(22) Filed: Sep. 28, 2001

Related U.S. Application Data
(60) Provisional application No. 60/235,990, filed on Sep. 28, 2000.

(51) Int. Cl. G06F 15/16

(52) U.S. Cl. 709/206

(57) ABSTRACT

The present invention comprises a system and method that modifies an email sender's email client or data files in order to enable automatic inclusion in an email message of an enabling device for voice, instant messaging or video communications. The sender's email client will thereafter by default effect this inclusion without requiring the sender to take any more steps than those required to send an ordinary email message. Upon receiving the email message, the recipient is presented with the included device, which provides the recipient an option to respond to the sender by voice, instant messaging or video. Upon choosing the option, the recipient will automatically download an applet or control to serve as a client for the requested mode of response.

### PRIORITY

This application claims the benefit of U.S. patent application No. 09/568,700 and U.S. Provisional Patent Application No. 60/235,990, filed May 11 and Sep. 28, 2000, respectively.

### FIELD OF THE INVENTION

The present invention relates to communications over telecommunications networks and, more particularly, to person-to-person multimedia communications, especially over broadband network connections, such as “voice-over-IP,” “instant messaging” and video communications, and more specifically to systems and methods for fostering the introduction of such communications by providing software that can embed within ordinary outgoing electronic mail messages devices that enable the recipient of the email message to respond via one of the new modes of communication. The techniques of the invention may be more generally applied to methods of acquiring users for any new mode or medium of telecommunications, and even more generally to methods of acquiring users for services and commercial offerings of virtually any nature over communications networks.

### BACKGROUND OF THE INVENTION

With the growth of the Internet in recent years, and the proliferation of higher speed connection devices, as well as broadband connections, it has become increasingly possible to conduct voice communications substantially of telephonic quality over routed Internet connections. In such communications, voice is digitized in accordance with an appropriate codec, and transmitted as IP packets using TCP/IP or other IP-based protocols. This technology is generally referred to as “voice-over-IP.” Also becoming practical with the advent of broadband is video communications over IP connections. “Instant messaging” such as provided by ICQ and America Online (AOL) Instant Messenger has also become popular, and some instant messaging clients include the capability to provide real-time voice communication.

The market for voice-over-IP and other advanced communications methods is expected to expand very rapidly, and possibly overtake the market for conventional telephony in the next several years. According to Business Week, voice on the Internet accounted for less than 1% of global telecom traffic in 1999, is expected to grow to 17% by 2003, and more than 30% by 2005. These changes are highlighted by transactions such as the $1.4 billion investment in Net2Phone in 2000 by a group led by AT&T.

Voice-over-IP is being introduced in many ways, in addition to direct marketing campaigns. For example, many e-commerce sites are increasing customer service by adding “click-to-talk” buttons. Many Web portals allow people to talk to one another without a telephone, using only a personal computer equipped with a microphone and a speaker. Computer-initiated calls can also be routed off the Internet through gateways, to conventional telephones, and conventional phones can call each other, going on and off the Internet through appropriate gateways.

Similar developments can be seen in video conferencing over the Internet, and similar new communications media.

Most of the computers sold today come equipped with the hardware necessary to support voice-over-IP communication. However, despite the surge in interest in voice-over-IP and other advanced media, a user still has to go out of his or her way to download appropriate client software to utilize these new services. Moreover, there are still a host of competing incompatible standards for voice-over-IP systems, subjecting this mode of communication to false starts and frustration. Companies investing in the field view customer acquisition as paramount. To be successful in this, it will be necessary to overcome the obstacles of getting proper and compatible software into the hands of consumers in a manner they find convenient.

It would be desirable to harness a communication medium that most users already have installed as a conduit to lead them to install the facilities for the new, not-yet-widely adopted medium. Electronic mail is widely installed today, yet in the current state of the art is used only indirectly for promotion, by circulation of advertisements suggesting some product to the recipient, and perhaps providing a link to click on. The advertising email message must be specially prepared and sent, usually as part of a bulk advertising project. The option exists to send communication clients via email as binary attachments, but such distribution is disfavored both because of the resulting size of the message, and because of its potential to carry viruses and other unwanted executable content. More active messages sent via email are known, but to date they have been used for destructive purposes, such as in the case of the “ILOVEYOU,” “LOVEBUG,” “MELISSA,” “BLUECODE,” and “NIMDA” email-borne worm viruses. It would be most desirable, therefore, to combine the ease and potential rapidity of dissemination of the latter forms of distribution with a commercial offering in a recipient-friendly, safe and controllable package in order to create an effective new means for online promotion and marketing.

### SUMMARY OF THE INVENTION

The present invention comprises a system and method that modifies an email sender's email client or data files in order to enable automatic inclusion in an email message of an enabling device for voice, instant messaging or video communications. The sender's email client will thereafter by default (i.e., unless overridden) effect this inclusion without requiring the sender to take any more steps than those required to send an ordinary email message. Upon receiving the email message, the recipient is presented with the included device, which provides the recipient an option to respond to the sender by voice, instant messaging or video. Upon choosing the option, the recipient will automatically download an applet or control to serve as a client for the requested mode of response. Preferably, this client will be framed in the user's browser in a manner that directly presents other choices, including the option to download the first software package mentioned, so as to establish on the recipient's machine the same capabilities as that possessed by the original sender, thereby facilitating the propagation of this technology as well as acquiring customers for the underlying service. Similar techniques may be employed for distributing other subject matter, such as advertising facilities.

In an alternative embodiment, the enabling device included in messages sent by the sender's modified email client is an “instant messaging” window embedded in the email message, preferably implemented in JavaScript. Upon opening the email message, the recipient, with no further action whatsoever, is in instant, real time contact with the sender, thereby providing farther excitement, as well as guidance, to induce the recipient to complete the transaction and download the any additional voice messaging client so as to be able to conduct farther communication by voice.

As will be readily appreciated from the foregoing summary and the detailed description of the preferred embodiment below, the invention provides a system and method for acquiring customers for voice-over-IP services or other advanced telecommunications services by simply and effectively distributing to user the requisite software to support such services using communications media and channels that the user already has available. Distinct advantages of the present invention are obtained by allowing each participating user to automatically propagate the invention technology to others with whom they communicate via such existing channels, as well as providing an implementation of the technology in a form that is self-installing, self-configuring, and that further provides the users with a means to register for additional services.

### BRIEF DESCRIPTION OF THE DRAWINGS

The preferred and alternative embodiments of the present invention are described in detail below with reference to the following drawings.

FIG. 1 is a block diagram illustrating the functional elements and the operational flow of the present invention.

FIG. 2 is a screenshot of a representative email message received in accordance of the present invention.

FIGS. 3 and 4 are diagrams of the database tables maintained by a server employed in the present invention.

FIGS. 5, 6 and 7 are diagrams showing the respective separate operations performed by the server, a sender and a recipient in accordance with the present invention.

FIG. 8 is a diagram of an alternative embodiment of the present invention showing a Voxster client residing behind a firewall.

FIG. 9 is a diagram showing a tree structure illustrating the relationship between a Voxster server, relays, and clients, in an alternative embodiment of the present invention.

FIG. 10 is a diagram showing an alternative embodiment of the present invention adapted to provide multilevel distribution of advertising based content.

### DETAILED DESCRIPTION OF THE PREFERRED EMBODIMENT

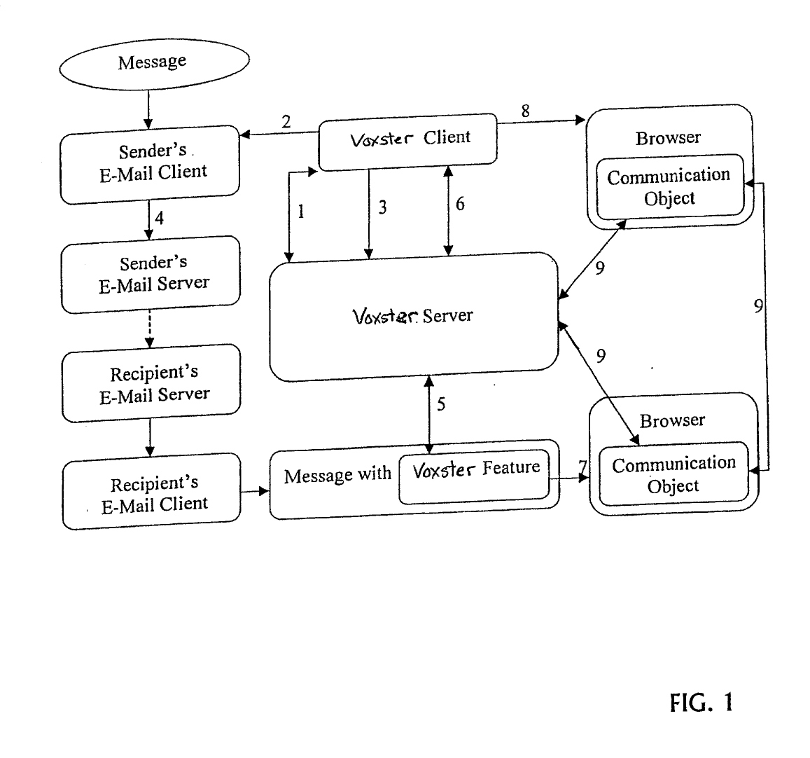

Various embodiments of the invention are illustrated in FIGS. 1 through 10 and described in the text that follows. Although the invention has been most specifically illustrated with particulars embodiments, it should be understood that the invention concerns the principles by which such embodiments may be designed, and is by no means limited to the configurations shown.

### The Voxster System

The functional elements and the operational flow of the present invention are better understood with reference to FIG. 1. This configuration may be implemented in a variety of ways. This discussion will be followed by a more general discussion of implementation techniques, which will in turn be followed by a series of alternative configurations for the invention, as well as alternate applications for its principles.

In the specific implementation referred to above, an electronic mail sender and recipient each use electronic mail clients that are MAPI enabled (i.e., support Microsoft's Message Application Programming Interface), and that display messages encoded in HTML format with embedded Javascript elements. The sender, at some time prior to communicating with the recipient, has downloaded (ref. numeral 1 in FIG. 1) onto his or her computer a client program for the present invention (sometimes referred to herein as the “Voxster client”). The Voxster client was downloaded by the sender from a server established in accordance with the invention (sometimes referred to herein as the “Voxster server”).

The Voxster client is provided in a self-installing file, which also configures itself upon installation. Upon installation, the Voxster client modifies (2) the sender's electronic mail client, via a COM add-in, so as to make the default operation of the electronic mail client to add a Voxster response device to outgoing email messages, and to add a button and corresponding menu command labeled “Disable Voxster,” which overrides the new default behavior for user-specified messages.

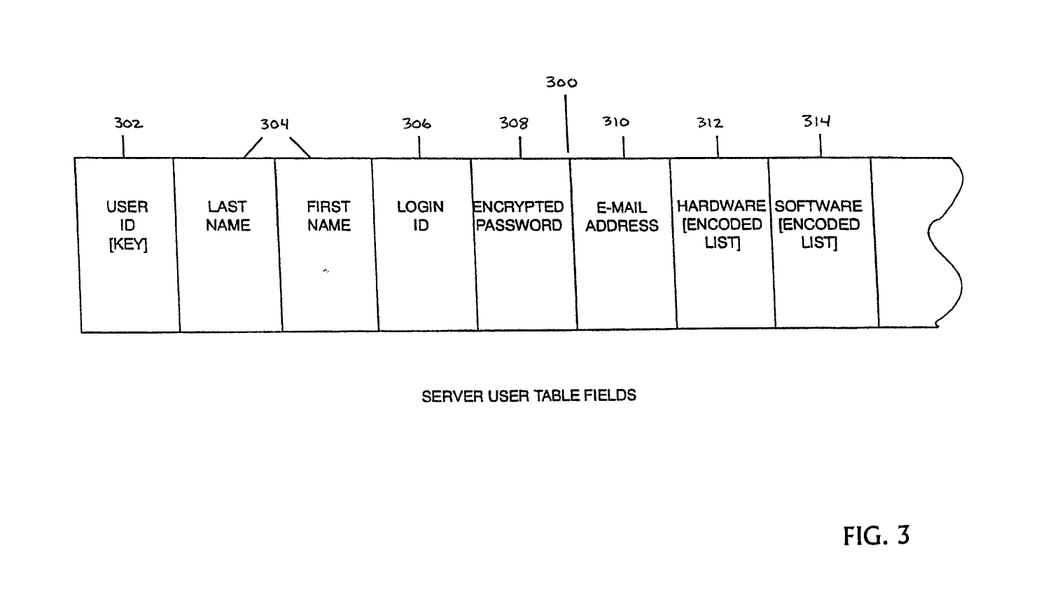

At the time of installation, information regarding the sender's communications facilities are sent to the server and stored in a database. This information (shown in further detail in FIG. 3, discussed below) includes a list of the sender's relevant communications hardware, as well as the communications clients and facilities that the sender has installed. At the time of installation, the Voxster client also installs a small voice-enabled communication client (herein referred to as a “communication object”). Also, once installed and running, the Voxster client periodically sends messages (3) to the Voxster server, updating the server's record of the sender's attributes and indicating the sender's status (e.g., whether the sender is online, his or her IP address, etc.).

The sender's email client, as modified by the downloaded software, functions as it normally does, except that in addition to merely sending the message that the sender has composed, it adds (4) a new coded section to the message. This new coded section provides the recipient with the option to respond to the message by voice rather than electronic mail. The new coded section may be labeled, for example, “Click HERE to respond by voice.” The email client is further modified to provide a new button in the toolbar and corresponding menu item to override this behavior on a message-by-message basis. If the user takes no special action (i.e., by pressing this button), the outgoing email will include a voice-response button by default.

In the implementation now being discussed, the voice-response button is an HTML coded button added to a portion of the outgoing message. When this HTML coded button is clicked by the recipient, it launches the recipient's Web browser and automatically starts downloading a voice-enabled communication object. In addition, by the use of Javascript (or similar facility), the button monitors information from the Voxster server, and is able to change so as to display the status of the sender, such as whether the sender is online and available to talk. The voice enabled communication object is a small object, preferably a Java applet or ActiveX control, whose principal function is to enable the user to have a voice conversation with the sender as promised.

Upon pressing the “respond by voice” button, the Voxster server is notified (5) and the server “rings” the sender (6). If the sender accepts the call, the recipient's communication object is launched (7) as a control in the recipient's Web browser, and the sender's communication object is similarly launched (8) as a control within the sender's Web browser. A channel having been established and opened, the sender and recipient may now talk to each other (9).

As noted above, the recipient's communication object is preferably downloaded as an applet or control that may be run within the recipient's Web browser. As such, it may be framed by a page presenting other options. Preferably, one such option is one to “download the entire application.” When the recipient exercises this option the same software that modified the sender's email client is now downloaded to the recipient, putting the recipient in the same position as the sender, with the consequent ability of the sender to send out his or her own email messages including a voice response button. In this manner, the voice-response capability may be rapidly spread from one user to the next, with the corresponding benefit of enhancing the ability to acquire additional users for new service.

More specifically, the operational process of the present invention is described with reference to the “steps” discussed above and shown in FIG. 1.

Step 1. Email message sender registers with the system (referred to as “Voxster” or the “Voxster server”) and downloads an application program (referred to herein as the “Voxster client”) to the sender's computer.

Step 2. The Voxster client on the sender's computer causes outgoing messages sent from that computer through the sender's email or other communications client to contain the Voxster device. The Voxster device comprises elements added to the message, which may be received by a recipient using another standard email (or other) client, which invites the recipient to engage in a voice-over-IP session (or other advanced messaging session), and takes steps to establish the requisite connection in a convenient, automated and intelligent manner.

The Voxster feature is incorporated into the sender's outgoing message by modifying a data or “signature” file for the sender's email client program. This may be accomplished by intercepting the outgoing message, parsing it, and adding an appropriate insertion (such as through MAPI, where supported, or even externally over the network), or by modifying the sender's email client program itself (or configuration files for the email client) so as to add the Voxster feature to an outgoing message. These measures can be effectuated through the Voxster client that the sender has downloaded (as above). Preferably, the messaging client is modified to include the Voxster device in outgoing messages by default, with a control added to override this behavior on a message-by-message basis. Alternatively, a button or other control can be provided to insert the Voxster device at the sender's option.

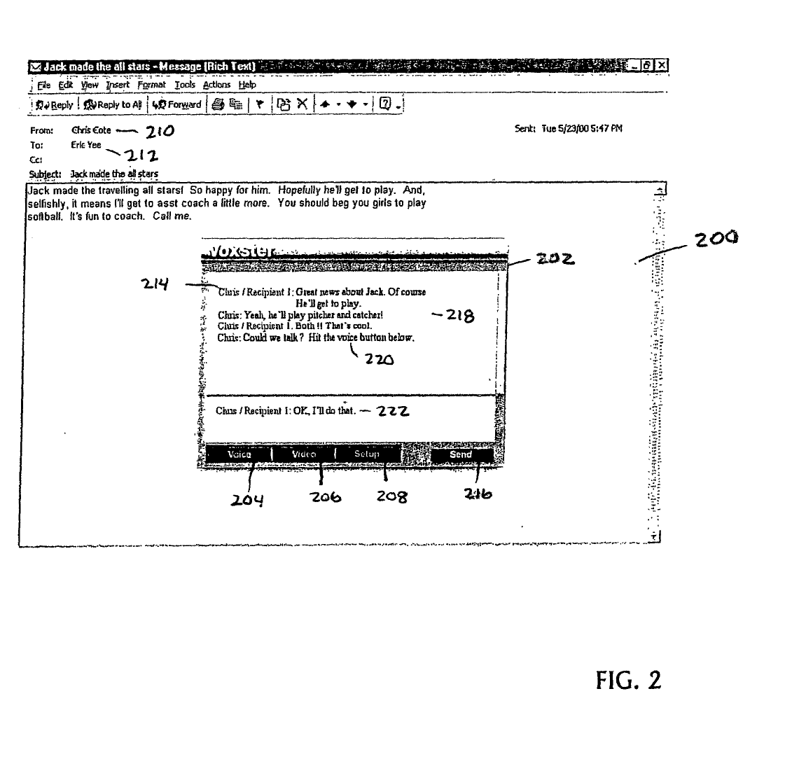

In an alternative embodiment of the Voxster device implementation, the Voxster device included in messages sent by the sender's modified email client is an “instant messaging” window embedded in the email message, preferably implemented in JavaScript. Upon opening the email message, the recipient, with no further action whatsoever, is in instant, real time contact with the sender. This alternative embodiment is further described with reference to FIG. 2.

FIG. 2 illustrates the body of a representative email message 200 received by an email recipient in accordance with the current improvement. Embedded in message 200 is an “instant messaging” window 202. The window is used for a relatively minimal instant messaging client having basic one-on-one chat capability and a several buttons (204, 206, and 208) to enable certain simple options and an upgrade.

The name of the sender of the exemplary email message is “Chris Cote” (210). By sending the e-mail message, the sender pre-registers the recipient (“Eric Yee” (212)) for the instant messaging service with a generic, numbered screen name, in this instance keyed to the senders screen name as “Chris/Recipient 1” (214). When the recipient responds for the first time within instant messaging window (202) by pressing “SEND” button (216), a browser window (not shown) launches, asking the recipient if he or she wishes to change his or her screen name. If the recipient desires to change the screen name, the new screen name will be saved in a “cookie” set on the recipient's computer.

Button 204 labeled “VOICE” will look for an appropriate voice messaging client on the recipient's computer and, if found, launch it within a browser window. If such a client is not found, an appropriate voice messaging client will be downloaded and launched within a browser window. Button 206 labeled “VIDEO” is similar in behavior to button 204, but instead begins a video communication sequence. Button 208 initiates a download to install the “further application” (the one that modifies the recipient's e-mail client), as previously described.

Shown in this example is a dialog 218 between the sender, Chris, and the recipient, Chris/Recipient 1. After briefly chatting about the subject of the e-mail, Chris suggests (220) that the recipient press the “VOICE” button and pick up the conversation via voice-over-IP communication. The response we see about to go out (below the line, 222) indicates that the recipient is about to take up this suggestion and press the “VOICE” button.

An option (not shown) is also provided to download a more full-featured instant messaging client.

Step 3. The Voxster client running on the sender's computer periodically notifies the Voxster server that the sender is on line. Other sender-related information is also updated to the Voxster server in this manner, including the sender's current IP address and detailed status information, as further discussed below in connection with the server.

Step 4. The sender's email client sends the email message containing the Voxster feature, as described above. The Voxster feature may be content coded in HTML, containing an HTML block to display state-related information in the recipient's email client. The state-related information can include an indication of the sender's present accessibility (e.g., online, offline, in “Do not disturb” mode, etc.). This information is obtained and updated by querying the Voxster server. The query may be initiated by, for example, Javascript commands embedded in the Voxster portion of the received message (using, for example, VBScript or other scripting or automation facility). In addition to such state-related information, the Voxster server may also return information regarding the sender's hardware (e.g., existence of a video camera, etc.), software (whether the sender has certain programs, such as NetMeeting, Net2Phone, etc.) and the like. The Voxster portion of the message can also display buttons for the recipient to click on, such as: “Reply by voice,” “Reply by video,” “Reply by instant messaging,” “Download application,” etc. It may also allow choosing the specific communications program desired by the recipient of the email in the event the Sender has installed more than one such program. In the preferred embodiment, the recipient selects one of the presented options in the Voxster portion of the received email by clicking on it. Alternately, a hierarchy or array of controls may be provided, for example, presenting a “jump page” or the like with an expanded list of options. Options presented could include a number of preconfigured contact channels that the sender has established, such as cell phone, pager, office phone, computer, etc.

Step 5. The Voxster feature in the message that has been received by the recipient contacts the Voxster server to determine if the sender is online and, if so, makes corresponding “rings” (see Step 6) on the recipient's computer.

Step 6. The Voxster server contacts the sender on behalf of the recipient. If the sender has several computers (home, work, laptop, etc.), a heuristic procedure (e.g., monitoring mouse movement, key presses, communications activity or other activity likely to be associated with active usage) will attempt to recognize the active computer to ring first. In an alternative implementation, the Voxster server may also ring on the sender's other computers. It may be the case that the sender's different computers use different communication programs (for example, the sender could have NetMeeting on his or her office computer, but not on his or her notebook computer). In this case, the system could employ an iterative procedure to choose an acceptable communication program.

Step 7. When the sender “answers” the call, the Voxster feature in the original message opens a web browser on the email recipient's computer. Preferably, the desired communications program client is established as a control or framed within the web browser. This control may be a “thin” communications client (e.g., Java applet or ActiveX control) downloaded by the recipient, either affirmatively or automatically, when initiating the response to the original email message. In an alternative implementation, it could be an existing communications client or program that the recipient has already installed on his or her computer. Alternately, for example, for clients that will not allow themselves to be run under a Web browser, the communications client and the Web browser could be opened separately (rather than as a “communication object” under a browser, as illustrated). The server provides the recipient's communications client with the sender's current IP address (that can be different from one that the sender had when he or she sent message). Preferably, the downloaded communication object runs within the recipient's browser, and is framed by a page providing options, including the option to download the “entire application.” The “entire application” is preferably the Voxster client of Step 1. When the recipient downloads the entire Voxster client, the recipient is placed in the same position as the original sender, i.e., with the ability to propagate the new communication facility to others in the same manner that the recipient received it. In an alternative implementation, additional options are presented to the user at this point, such as a registration frame, or a presentation of explanations or other content or subscription options. The possibilities for communications clients are varied and flexible. Other options could include providing for communications through a third-party client, such as NetMeeting (which will run within a browser), Net2Phone (run as a standalone application), and various instant messaging and chat clients (e.g., AOL Instant Messenger).

Step 8. When the server rings the sender, the sender's Voxster client opens a web page in sender's browser (or other interface), offering the sender the opportunity to open two-way communication. The web browser or other interface opens with a “communication object,” which may be an applet or control corresponding to the recipient's communication object. (The recipient has chosen the media and communication program and this information had been sent with the ring to the Voxster client.) Alternately (as above), the sender's communication client could be opened as a standalone application.

Step 9. By the time this initial contact has been established, the control on the recipient's computer and the sender's Voxster client know the IP addresses of each other and can open direct channel or communicate through server (for example if they are behind firewall). The channel can be a voice-over IP channel, video channel, instant messaging, chat or other mode of communication, as selected by the parties to the conversation as outlined above.

### Actions of the Voxster Server, Sender and Recipient

The following discussion focuses particularly on the functions performed by the server, the sender and the recipient in a system such as that described herein.

### The Voxster Server

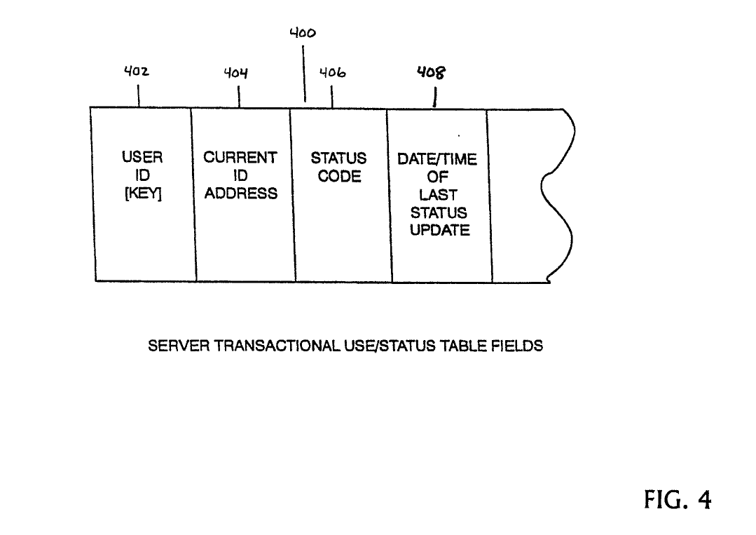

The tables maintained by the Voxster server are shown in FIGS. 3 and 4. There are two tables, a user table 300 (FIG. 3) and a transactional user/status table 400 (FIG. 4).

The user table 300 may contain the following information:

User ID (primary key) 302

First Name, Last name, etc. if needed 304

Login 306

Password 308

Email address 310

Hardware installed (including those from a list of supported hardware) 312

Relevant software installed (i.e., those from list of supported software); includes binary code about the communication programs that user has on his or her computer from the list of programs supported, such as Net Meeting, Net2Phone, etc. 314

The login and password fields enable installation of the Voxster client on several computers for the same user.

The transactional user/status table 400 may contain the following:

User ID (also the primary key) 402

Current IP address 404

Status code: Available, Off line, Busy (conversation with other recipient), Do not Disturb, and Sleep (other computer belonging to the same user is recognized as active) 406

Date/time of the last status update 408

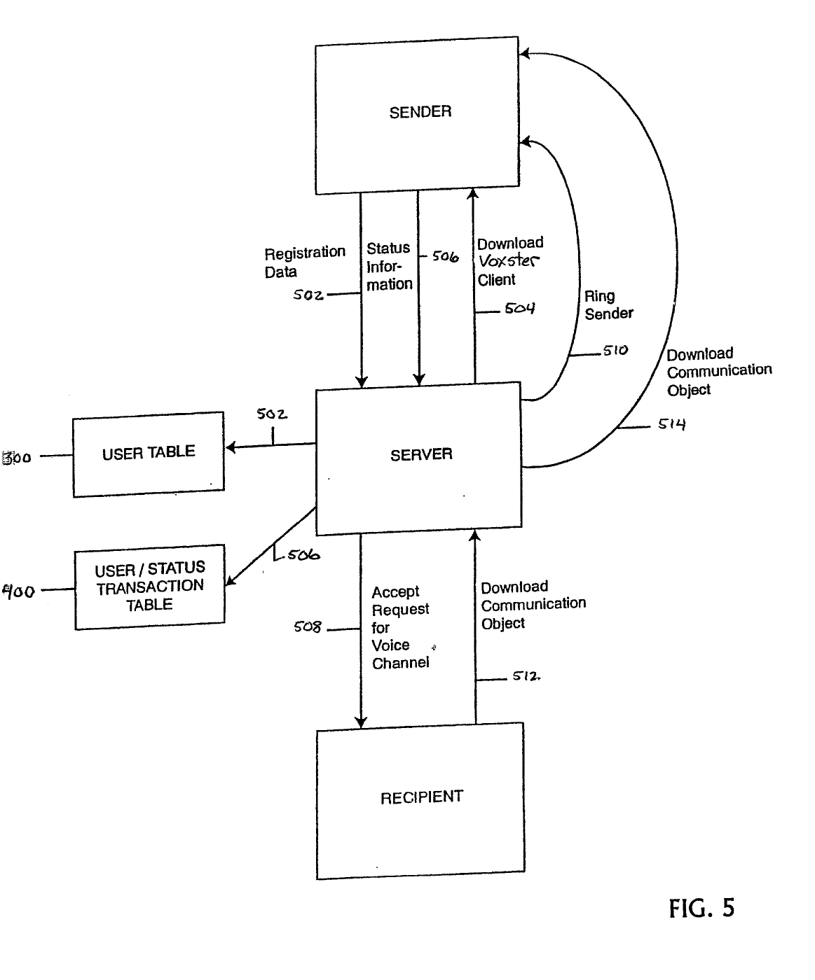

FIG. 5 shows the functions supported by the Voxster server, including:

Accept user registration and create entry for the user in user table 502

Provide download of Voxster client (may be performed by a separate server) 504

Accept status information periodically sent by user (506) and update user/status table 400

Accept request to open voice channel from recipient of email message 508

Ring sender of email, preferably at active computer 510

Download communication object to recipient (may be performed by a separate server) 512

Download communication object to sender (if necessary) 514

### The Voxster Sender

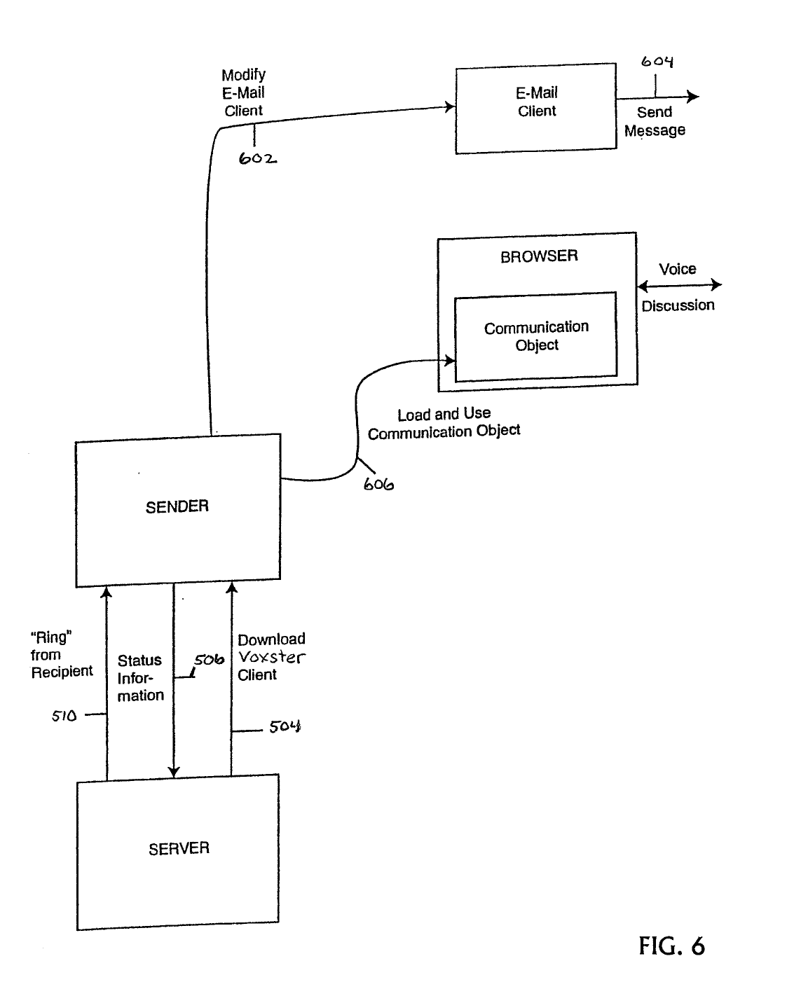

FIG. 6 shows the functions that may be performed by the Voxster sender, including:

Download (or otherwise obtain) Voxster client 504

If necessary, use Voxster client to modify email client to add voice-response device to outgoing emails 602

Send email containing device 604

Notify Voxster server periodically of sender's status 506

Accept “ring” from recipient 510

Load or give control to communication object, and engage in voice discussion 606

### The Voxster Recipient

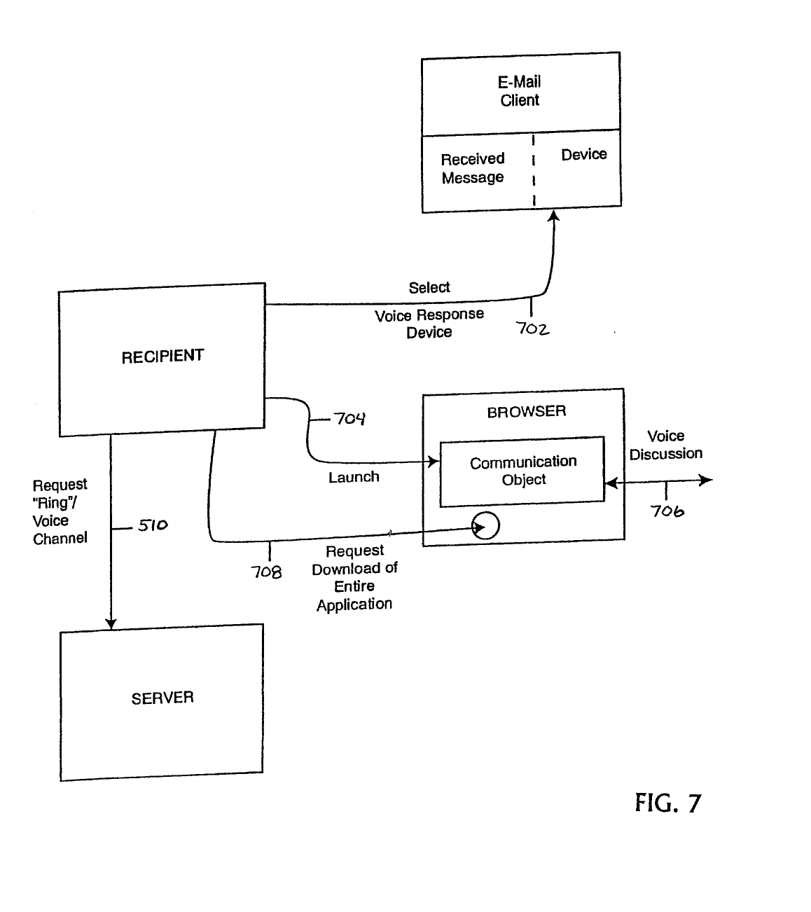

FIG. 7 shows the functions that may be performed by the Voxster recipient, including:

Select voice response feature in received email 702

Pass on “ring” request for sender to the server 510

Launch communication object within browser 704

Engage in voice discussion 706

Optionally elect to download entire application 708

### Alternative Embodiments of the Present Invention

There exist many foreseeable variations or alternative embodiments of the present inventions that fall with the scope contemplated by this disclosure. The following is a nonexclusive list presenting examples of such alternative embodiments.

Alternative 1. The default feature set of the email client could be modified to include the capability described in Step 1, or some of the capability of the communications client described in Step 7.

Alternative 2. The sender's email client could be modified or originally configured to send the type of Voxster email message herein described by default or according to a pre-established filter, rather than by giving the user an email by email option. In addition, the email client could be patched, upgraded or completely replaced with a substitute. For example, the Voxster feature could be inserted through a server that intercepts the outgoing message without modifying the client program.

Alternative 3. A button or other control could be placed in a location other than the sender's email client, but designed to have the same effect. For example, a control in a menu provided at the operating system level, or alternatively a standard function of the operating system.

Alternative 4. The button or control described in Step 1 (for the user) and Step 4 (for the recipient) could be replaced by links or other means of user input.

Alternative 5. The communication link on the recipient side could be opened automatically instead of as a result of affirmative recipient action (e.g., a click).

Alternative 6. The recipient may initiate action by providing input other than via the email message, such as in another client or operating system-provided interface, rather than via the clickable link described in Step 4.

Alternative 7. The functionality of the Voxster client could be provided as part of another program (e.g., browser, operating system, etc.) rather than on a dedicated, standalone basis.

Alternative 8. The system could be configured to detect previously downloaded elements to avoid downloading files that are identical to those already downloaded, or to provide options for downloads of varying size and capabilities. Alternatively, the Voxster portion of the recipient's incoming email could contain all of the code necessary to launch the required communications client. The client software could also check the destination of the email, and determine what action to take based upon the destination, such as whether to include an embedded thin client.

Alternative 9. It should be clear that all of the capabilities described herein can be configured to work equally well regardless of whether the communications channel to be opened between the sender and recipient of the initial email is voice, instant messaging, video, or a yet to be developed form of electronic communication.

Alternative 10. Instead of launching a communications client directly, the system on either end could call another piece of installed software, such as a browser, in such a manner as to cause it in turn to activate the desired communications channel.

Alternative 11. It should be appreciated that the communications client selected could have the capability to support other than computer-to-computer communications, such as by initiating a voice call that is switched to a telephone relay on an ordinary telephone network. For example, the initial email could designate a voice back response to the user's ordinary phone number, and the designated communications client could have the ability to place such a call from the recipient's computer.

Alternative 12. The sender's email could initiate the automatic installation of the recipient software upon the opening of the sender's email, rather than upon the recipient affirmatively initiating such installation with a click.

Alternative 13. The Voxster (or alternative) client could provide the ability to choose service providers as well as communications clients as indicated in Step 7.

Alternative 14. Email messaging protocols or standards could be modified or supplemented to provide for a voice back section as described herein.

Alternative 15. Service providers could devise means for selectively or generally blocking communications of the type herein described, such as by parsing the message to detect particular MAPI coding, or by other pattern recognition algorithms, and either stripping out the coding or otherwise disabling it. The service provider could block all communication types or ports other than those it has authorized.

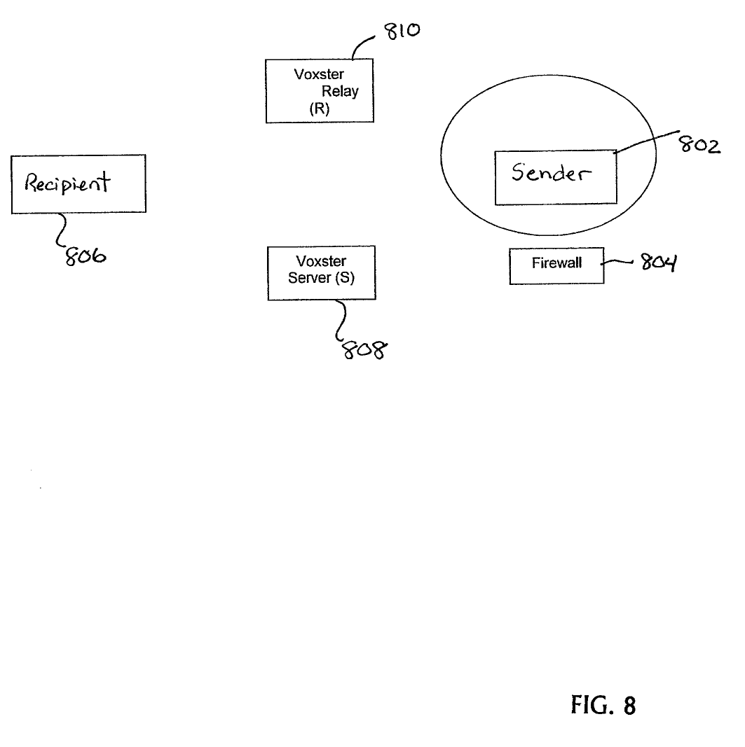

Alternative 16. In an alternative embodiment, the present invention is implemented into a network that may include a firewall. In this example, a sender having a Voxster client installed desires to contact a recipient who does not have a Voxster client installed. This embodiment is better understood with reference to FIG. 8.

A sender 802 having an installed Voxster client (not shown) residing behind a firewall 804 sends an email to a receiver 806. The email includes a graphical, clickable link embedded in the email, indicating that the sender desires to communicate with the recipient, for example via online chat or web-phone. At a later point in time, the recipient opens the email. In a preferred embodiment, the embedded graphic link in the email indicates whether the sender is currently online. The recipient subsequently clicks the link to initiate the communication with the sender, which action may cause a download of the appropriate communication object, as described above.

Initially, sender 802 must determine whether it is behind a firewall. The sender, via the Voxster client, pings a Voxster server 808 and waits. If the Voxster server does not respond after a fixed timeout period, the sender deems itself to be behind a firewall. If the sender is behind a firewall, the sender initiates a request to the Voxster server for a list of clients (preferably five) that are currently online and not behind the firewall. The Voxster server provides the sender with a list of accessible clients, which are referred to as Voxster relays 810. The Voxster server notifies the Voxster relay whenever communication requests are waiting for the sender.

When the recipient clicks on the embedded graphic link, the Voxster server is notified that a communication request is being placed to the sender from the recipient. The Voxster server, in turn, notifies the Voxster relay, supplying the Voxster relay with the IP address of the recipient.

The sender periodically makes a request to the Voxster relay to determine whether any communication requests are waiting for the sender. The sender starts with the first Voxster relay on the list. If the first Voxster relay does not return the request, the Voxster relay is deemed offline, and the sender sends a request to the next Voxster relay on the list, and so on. If the list is exhausted, the sender requests a new list of Voxster relays from the Voxster server. Assuming that a communication request is pending, the sender will eventually make contact with a Voxster relay having the IP address of the recipient, which was previously provided by the Voxster server, and receive the recipient's IP address. With the IP address of the recipient provided by the Vortex relay, the sender is able to connect directly to the recipient (e.g., via peer-to-peer), with no additional workload on the sender. At that point, the communication, such as a chat or web-phone call from the recipient to the sender, begins.

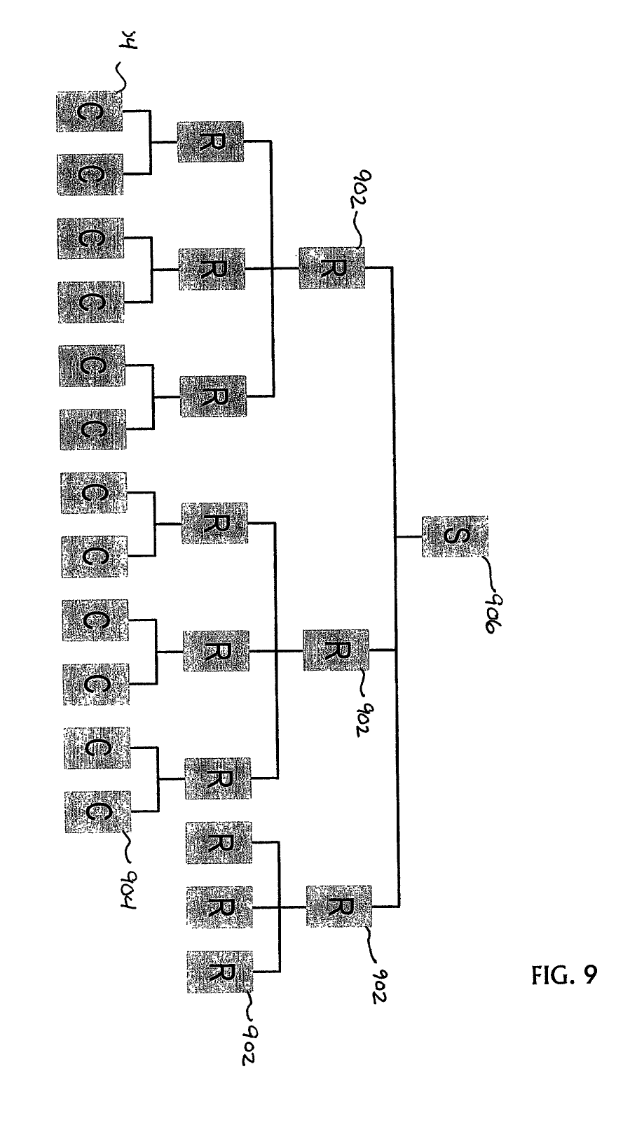

Alternative 17. In yet an alternative embodiment, the Voxster relays, as described above, may be used as part of a communication load balancing process. This embodiment is better described with reference to FIG. 9. In this example, Voxster relays 902 and Voxster clients 904 are arranged in a tree structure stemming from a Voxster server 906. Use of the tree structure further reduces the load on the server because individual status information for the Voxster clients that are children of or “below” a certain Voxster relay can be aggregated in a single message send to the Voxster relay (and in turn to the Voxster server) that covers all clients below it in the tree. Among other benefits, this minimizes the frequency of disruptive communication between individual Voxster clients and the Voxster server.

### Additional Implementations of the Present Invention

The technology described above constitutes in effect a “viral” distribution mechanism over existing communications media in order to acquire customers for a new telecommunications medium in a very rapid, inexpensive and efficient manner. The same technologies may be used for other business purposes.

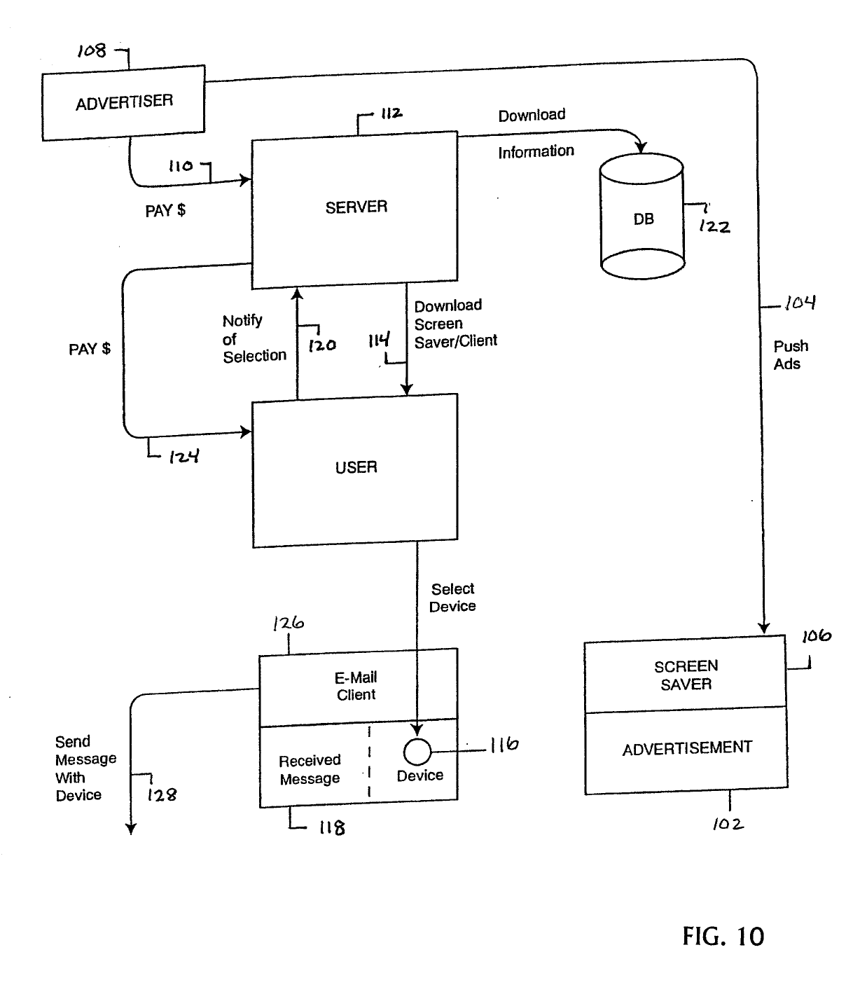

For example, as shown in FIG. 10, the present invention may be used to establish a multilevel marketing arrangement. In one such embodiment, advertisements 102 may be pushed seriatim 104 to a screen saver 106. An advertiser 108 pays 110 the proprietor of server 112 for the advertiser's advertisements to be presented in this manner. The screen saver 106 is distributed by download 114, which is initiated by a button or other control 116 included in an email message 118. Server 112 is appropriately notified 120 of the user selection. Server 112 keeps track of the downloads, maintaining the trail of users that led to a particular download in a database 122. Advertising revenue may be attributed to users in the chain, and the users may be compensated accordingly 124 from the gross revenues. This provides an incentive to the recipient of each enabled email to send a similar message to another person. The mechanism, also contained in the download 114 (or otherwise provided by server 112), modifies the recipient's email client 126, etc. to include such a control 116 in an outgoing message 128, as previously described with respect to the Voxster client in the voice-over-IP example.

The distributed service need not necessarily provide a monetary benefit to the email sender. For example, if the facility provided is pleasing or interesting to use or watch, the user may perceive a personal benefit merely from distributing it to friends and acquaintances gratis.

Essentially, the same technology may be used to distribute any downloadable software-operated facility of any nature that is in any manner deemed desirable by the network using population, either because it makes money for them or because it provides some other non-pecuniary benefit. Collaterally, the service may generate business or revenues for the original propagator or the operator of the server. The same technique is generally useful as a powerful means to acquire customers for a broad range of services that may be supported by software capable of being downloaded. As available network bandwidth increases, there is no practical limit on the types of services that may be so supported. A button, link or other control to initiate the download of such software may be provided over an existing channel, such as email, and such software may be downloaded to the sender's machine in order to modify an existing client for the channel so as to automatically insert such button, link or other control.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. In an environment having an electronic mail communications medium used by all members of a certain set of users, and a second communications medium used by fewer than all such users, a system for introducing to the remaining such non-users of said second communications medium a facility for adopting said second communications medium, comprising:
a computer used by a first one of said users, said computer having a client program for said electronic mail communications medium;
a computer used by one of said remaining non-users of said second communications medium, said computer also having a client program for said electronic mail communications medium;
computer software adapted to modify said client program of said first user so as to cause said client program to include in messages sent therefrom an embedded instant messaging window device to enable said non-users of said second communication medium to access a facility for adopting said second communications medium; and
a server for coordinating communications of said first user and said remaining non-user.
